(19) United States
(12) Patent Application Publication
(10) Pub. No.: US 2003/0154872 A1
(43) Pub. Date: Aug. 21, 2003

(54) Cylinder

(76) Inventor: Wolfgang Knoll, Lambsheim (DE)

Correspondence Address: Douglas R Hanscom, Jones Tullar & Cooper, Eads Station, P O Box 2266, Arlington, VA, 22202, US

(21) Appl. No.: 10/275,266

(22) PCT Filed: Jan. 26, 2001
(86) PCT No.: PCT/DE01/00321

(30) Foreign Application Priority Data
May 12, 2000 (DE) 100 23 205.1

(51) Int. Cl. B41F 5/00; B41F 13/10

(52) U.S. Cl. 101/375; 101/216

(57) ABSTRACT

The invention relates to a cylinder in a rotary press, in particular, for interacting with a form cylinder for a gravure press. According to the invention, the cylinder is improved with regard to its variable adaptability by the provision of a linear drive located at the end of the cylinder between the fixed support and rotating outer surface. Said linear drive operates in a vertical radial direction upwards toward the inner ring of a roller bearing.

### The invention relates to a cylinder in accordance with the preamble of claim 1.

A counter-pressure cylinder has become known from DE 30 33 230 C2, whose journal is held in end plates. In this case an actuating element acts on each of the free ends of the journals protruding out of the end plates for the metered introduction of pressure forces for the purpose of compensating the sagging of the cylinder.

U.S. Pat. No. 4,913,051 discloses a cylinder of a rotary printing press, wherein a jacket of the cylinder is seated by means of rolling bearings on a support. A distance in the radial direction between the jacket and the support at the ends is permanently fixed by means of the rolling bearings. Further rolling bearings with adjusting means for changing the distance between the jacket and the support are arranged between these rolling bearings.

The object of the invention is based on creating a cylinder.

In accordance with the invention, this object is attained by means of the characteristics of claim 1.

The advantages to be achieved by means of the invention reside primarily in that the introduction of the placement force takes place via the shaft and the bearings arranged between the jacket and the shaft. Because of this, tube bending, which corresponds to the tendency of the cylinder bend, already occurs when the cylinder is put down. The bending compensation takes place via the exterior bearings.

By arranging a bearing with an adjustment drive at the ends of the jacket, weakening because of the space requirements of the adjustment drive becomes necessary only in the area of the ends of the support, or jacket. In contrast to actuating drives located in the interior, this results in an improved flexural strength.

The interior and exterior bearings are placed within a common hydraulic fluid circuit, therefore later greasing of the bearings is not necessary. Further than that, a permanent fluid circulation between both ends of the counter-pressure cylinder leads to the removal of the heat from the rubber-coated cylinder jacket, which was generated by the flexing of the rubber blanket.

A shorter shaft distance and a shorter total length result. because all bearing points are housed inside the tube jacket, an improved installation possibility is created because of this, also when retrofitting existing presses.

The design of the shaft seating makes assembly and disassembly easier in comparison with known embodiments.

An exemplary embodiment of the invention is represented in the drawings and will be described in greater detail in what follows.

Shown are in:

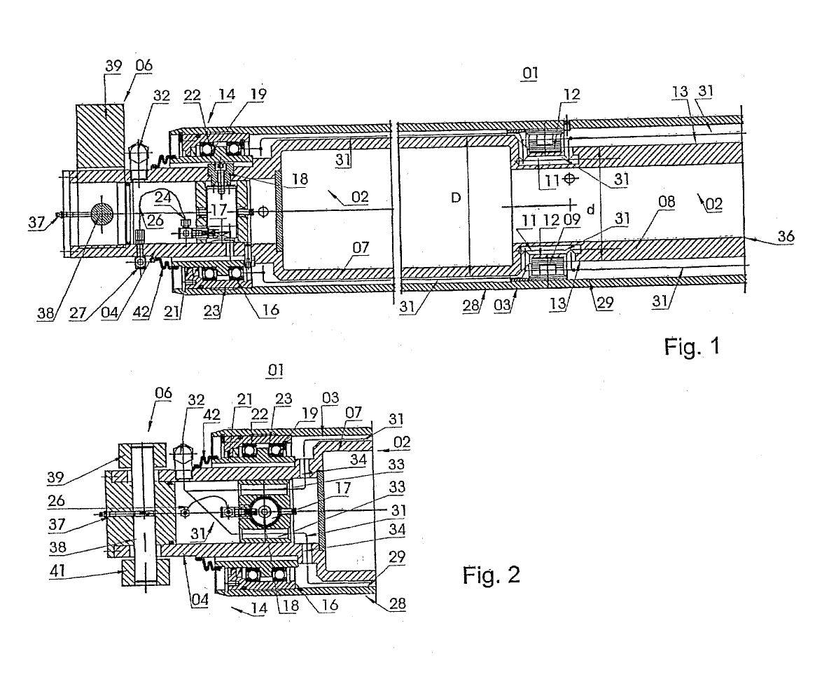

FIG. 1, a schematic representation of a longitudinal sectional view through the left portion of a cylinder in the vertical direction,

FIG. 2, a portion of the longitudinal section in FIG. 1, but in the horizontal direction.

A cylinder 01, for example a counter-pressure cylinder 01, in particular an impression cylinder for a rotogravure forme cylinder, for example in a rotary printing press, consists of a shaft or support 02 with a rotatable tube-shaped jacket 03, whose journals 04 are seated, fixed against relative rotation, in a bearing and lifting device 06. The support 02 located between the journals can be made of several parts and can consist, for example, of a shaft 07 in the form of a hollow cylinder of a greater diameter D and a tube 08 of a lesser diameter d, which is seated between these shafts 07.

Rolling bearings 09, for example cylindrical rolling bearings 09, are arranged between the rotatable tube-shaped jacket 03 and the stationary support 02. The tube 08 is embodied with thick walls and has several bypasses 11 on its circumference, which are conducted around the silhouette of the inner ring 12 of the cylindrical rolling bearing 09 and terminate with their respective openings at the exterior of the tube 08.

Each end 14 of the jacket 03 is seated by means of a rolling bearing 16, for example a deep groove ball bearing 16, on the respective journal 04 of the support 02. An actuating device 17, for example a working cylinder 17, is arranged between the support 02 and the jacket 03, whose tappet 18 acts in a vertical radial direction away from the support 02 upward against an inner ring 19 of the deep groove ball bearing 16.

A rolling bearing 16 with an actuating drive 17 for changing the distance between the jacket 03 and the support in the radial direction is arranged in the area of each end 14 of the jacket 03. One or two rolling bearings 09 without the capability of changing the distance between the jacket 03 and the support in the radial direction are arranged between these rolling bearings 16 with actuating drives 17.

The inner ring 19 of each deep groove ball bearing 16 is supported by a bushing 21. The outer ring 22 of the deep groove ball bearing 16 is surrounded by a concentrically arranged bushing 23.

Each working cylinder 17 has a fluid feed 24, which is connected via a line 26, for example a high-pressure hose, screw connection 27 and further lines with a hydraulic oil source, not represented. Depending on the requirements, the working cylinders 17 arranged on both ends can be actuated individually or together.

On its outer surface 28, the jacket 03 has an elastic cover, for example made of caoutchouc, not represented.

On its inner surface 29, the rotatable jacket 03 of the counter-pressure cylinder 01 comes into contact with a fluid, for example oil from a lubricant and coolant circuit 31. The lubricant and coolant circuit 31 extends from a first fluid inlet or outlet 32 in the first hollow journal 04 to a second fluid inlet or outlet in the second hollow journal, not represented.

In a flow direction from right to left, axial bores 33 extend on both sides of the working cylinder 17, and radial bores 34 in the journal 04 follow them (FIG. 2). The fluid is further conducted in a space between the support 02 of the diameter D, d, and the inner surface 29 of the jacket 03. Thereafter, the fluid runs to the bypasses 11 and enters through the outlets into the space between the exterior 13 of the tube 08 with the diameter d and the inner surface 29 of the jacket 03.

Behind a succeeding vertically extending center line 36, the counter-pressure cylinder 01 extends laterally reversed (FIG. 1), i.e. the fluid reaches the fluid inlet or outlet 32 in the right journal 04 in the reversed sequence of the above description.

The rolling bearings 09, 16 are lubricated by means of this fluid flow, and the inner surface 29 of the jacket 03 is cooled. The lubricant and coolant circuit 31 is operated at a fluid pressure starting at approximately two bar, in particular at approximately five bar. The throughput of fluid is at least 10 l/m, preferably approximately 30 l/min. Because of the flexing of the rubber blanket, the inlet temperature of the fluid of approximately 18° C. rises to an outlet temperature of more than 40° C. The fluid is cooled down to the previously mentioned inlet temperature by a lubricant-coolant circuit, not represented.

The bearing and lifting device 06 consists of a bearing bolt 38, which is secured by means of screws 37 and passes through the journal 04 and is furthermore seated in height-adjustable lifting arms 39, 41.

The multi-part support 02 can be screwed or welded together at points which are not represented.

A sealing element 42, for example a bellows 42, is arranged between the outer circumference of the journal 04 and the bushing 21 for preventing the fluid from being forced out.

It is possible to set a bending line for different forme cylinders with different diameters by means of varying the exerted bending pressure of the working cylinder 17 on the ends 14 of the tube-shaped jacket 03, for example with a pressure between 10 and 95 bar. Thus, for forme cylinders with a reduced circumference of approximately 800 mm, a pressure of approximately 90 bar can be provided, and for forme cylinders of a circumference of approximately 1,700 mm, a pressure of approximately ten bar can be provided.

The jacket 03 can selectively be made of steel or aluminum, for example.

### List of Reference Symbols

01 Cylinder, counter-pressure cylinder

02 Support (01)

03 Jacket, tube-shaped (01)

04 Journal (02)

05 —

06 Bearing and lifting device (01)

07 Shaft (02)

08 Tube (02)

09 Rolling bearing, cylindrical rolling bearing (02)

10 —

11 Bypass

12 Inner ring (09)

13 Exterior (08)

14 End (03)

15 —

16 Rolling bearing, deep groove ball bearing (04)

17 Actuating device, working cylinder (07)

18 Tappet (17)

19 Inner ring (16)

20 —

21 Bushing (19)

22 Outer ring (16)

23 Bushing (22)

24 Fluid feed (17)

25 —

26 Line

27 Screw connection

28 Outer surface (03)

29 Inner surface (03)

30 —

31 Lubricant and coolant circuit

32 Fluid inlet, outlet

33 Axial bore

34 Radial bore

35 —

36 Center line (01)

37 Screw (38)

38 Bearing bolt (04)

39 Lifting arm (01)

40 —

41 Lifting arm (01)

42 Sealing element, bellows (04)

D Diameter (07)

d Diameter (08)

1. A cylinder (01) having a support (02), which is fixed against relative rotation, and a rotatable jacket (03) seated thereon by means of rolling bearings (09, 16), wherein at least one first rolling bearing (16) is arranged with an associated actuating device (17) for changing the distance in the radial direction between the support (02) and the jacket (03), and wherein at least one second rolling bearing (09) is arranged, which fixes in an unchangeable manner the distance in the radial direction between the support (02) and the jacket (03), characterized in that the rolling bearing (16) with the actuating device (17) is arranged at the end (14) of the jacket (03).

2. The cylinder (01) in accordance with claim 1, characterized in that at least one rolling bearing (16) with an actuating device (17) is arranged on each one of the two ends (14) of the jacket (03).

3. The cylinder (01) in accordance with claim 2, characterized in that at least one rolling bearing (09), which fixes the distance in an unchangeable manner, is provided between the rolling bearings (16) arranged at the ends (14) and having the actuating devices (17).

4. The cylinder (01) in accordance with claim 1, characterized in that the rolling bearing (16) is embodied as a deep groove ball bearing (16).

5. The cylinder (01) in accordance with claim 1, characterized in that the actuating device (17) is embodied as a working cylinder (17).

6. The cylinder (01) in accordance with claim 5, characterized in that the working cylinder (17) can be charged with a hydraulic pressure between 10 and 95 bar.

7. The cylinder (01) in accordance with claim 1, characterized in that the rotatable jacket (03) has an elastic cover on its outer surface (28).

8. The cylinder (01) in accordance with claim 7, characterized in that on its inner surface (29) the rotatable jacket (03) is in contact with a fluid of a combined lubricant and coolant circuit (31).

9. The cylinder (01) in accordance with claim 1, characterized in that the rolling bearings (16, 09) arranged between the jacket (03) and the support (02) are in contact with a fluid of a combined lubricant and coolant circuit (31).

10. The cylinder (01) in accordance with claim 1, characterized in that at its ends, the support (02) has a fluid inlet (32) and a fluid outlet (32), between which an amount of at least ten liters of fluid/min can be conveyed.

11. The cylinder (01) in accordance with claims 8, 9 or 10, characterized in that the fluid leaving the fluid outlet (32) can be cooled down to a low feed-in temperature.

12. The cylinder (01) in accordance with claims 8 or 9, characterized in that the fluid pressure of the lubricant and coolant circuit (31) is at least two bar.

13. The cylinder (01) in accordance with claim 1, characterized in that the actuating device (17) is arranged so that it acts against an inner ring (19) of the rolling bearing (16).

14. The cylinder (01) in accordance with claim 13, characterized in that the inner ring (19) of the rolling bearing (16) is supported by a bushing (21).

15. The cylinder (01) in accordance with claim 1, characterized in that the outer ring (22) of the rolling bearing (16) is surrounded by a concentrically arranged bushing (23).

16. The cylinder (01) in accordance with claim 1, characterized in that the cylinder (01) is arranged in a rotary printing press.

17. The cylinder (01) in accordance with claim 1, characterized in that the cylinder (01) is embodied as a counter-pressure cylinder (01).

18. The cylinder (01) in accordance with claim 17, characterized in that the counter-pressure cylinder is arranged in a rotogravure printing press.
